(19) United States
(12) Patent Application Publication
(10) Pub. No.: US 2005/0238796 A1
(43) Pub. Date: Oct. 27, 2005

(54) Method of fabricating composite cathodes for solid oxide fuel cells by infiltration

(76) Inventors: Tad John Armstong, Salt Lake City, UT (US); Anil Vasudeo Virkar, Salt Lake City, UT (US)

Correspondence Address: JAMES SONNTAG;JAMES SONNTAG, PATENT ATTORNEY, P.O. BOX 2618, SALT LAKE CITY, UT, 84110-2618, US

(21) Appl. No.: 10/831,384

(22) Filed: Apr. 22, 2004

(51) Int. Cl. B05D 5/12; B05D 3/02

(52) U.S. Cl. 427/58; 427/226

(57) ABSTRACT

In the manufacture of a composite cathode, a porous structure is made of the electrolyte material by sintering a mixed material of primary material of the electrolyte and a secondary material. The mixture is treated to sinter the primary material. The secondary material is removed. The secondary material during sintering inhibits porosity loss and grain growth in the primary material while enabling formation of good necks for interparticle contact. The porous structure is then infiltrated with a liquid that contains precursors of an electrocatalytically active material. The infiltrated structure is then heated to convert the precursors to an electrocatalytically active material.

### CROSS REFERENCE TO RELATED APPLICATIONS

(Not applicable)

### FEDERAL RESEARCH STATEMENT

(Not applicable)

### BACKGROUND OF INVENTION

The three standard designs of solid oxide fuel cells (SOFC) are electrolyte-supported, cathode-supported, and anode-supported. The performance of electrolyte-supported cells is limited by the large ohmic losses due to the thick electrolyte, while that of cathode-supported cells is limited by the large overpotentials at the supporting cathode electrode. It has been shown that the performance of anode-supported cells is superior to that of electrolyte and cathode-supported cells due to the reduced thickness of the electrolyte and cathode, as well as the low overpotentials exhibited by the anode support. Even so, in such cells the largest contribution to overpotential losses is from the cathode while the ohmic losses from the electrolyte and overpotential losses at the anode are considerably smaller.

The two main contributors to the polarization at the cathode are (1) concentration polarization due to resistance to gas flow, and (2) activation polarization due to limitations in the charge-transfer process. Concentration polarization can be minimized by fabricating cathodes with enough connected porosity so as not to restrict gas flow. Activation polarization in the cathode is largely dictated by (1) the electrochemical properties of the materials, and (2) microstructure. As has been previously demonstrated, one way to reduce activation polarization is with the use of composite cathodes.

The composite cathode is comprised of two materials, (1) an electrocatalytically active material with good electrical conductivity such as, but not limited to, La₁₋ₓSrₓMnO_{3-δ} (LSM) or La₁₋ₓSrₓCoO_{3-δ} (LSC), and (2) a solid electrolyte exhibiting good oxide ionic conductivity such as yttria stabilized zirconia (YSZ) or samaria-doped ceria (SDC). The advantage of such a cathode is that the electrochemical reaction zone is spread out through the entire thickness of the cathode and is not limited to the cathode/electrolyte interface. In such a cathode, the performance is highly dependent on the microstructure. Thus, for a composite cathode of given materials, such as LSM/YSZ, the effective charge transfer resistance is a function of, and decreases with, the length of the three-phase boundaries between the solid electrolyte (YSZ), the electrocatalyst (LSM), and the gas phase.

Typically, composite cathodes are fabricated by mixing or milling the solid electrolyte (YSZ) and the electrocatalyst (LSM) together with or without a pore former. The resulting composite powder is applied to the electrolyte of the solid oxide fuel cell either by screen printing, spraying, or painting. The resulting powder mixture is then typically fired at temperatures between 1000° C. and 1200° C. to partially sinter the powder and burn out any pore former. Although reasonably successful, there are some limitations to this method of fabrication. First, the amount of porosity may not be adequate due to the partial sintering that occurs at temperatures above 1000° C., particularly at or above 1 150° C. Even with the addition of pore formers, the porosity may not be continuous (open) or have the desired morphology for optimal gas flow. Secondly, the total three-phase boundary (TPB) length can be dramatically decreased due to the over-sintering that can occur at those high temperatures. In addition, if the formation of pores occurs preferentially within one of the two materials in the composite, as opposed to forming at their phase boundary, then the total TPB length in the composite may be diminished. Thirdly, chemical reactions can occur between the solid electrolyte and the electrocatalyst at these high sintering temperatures resulting in the formation of undesired and often highly insulating phases. For example, LSM and YSZ react at temperatures above 1200° C. to form the impurity phases La₂Zr₂O₇ and SrZrO₃, while LSC reacts with YSZ at temperatures as low as 1000° C.

Firing the composite powder for the sintering at a lower temperature may mitigate the problems of loss of porosity, decrease of TPB length, and undesirable chemical reactions, but if the temperature is too low the electrolyte phase will be poorly sintered with poor interparticle contact or necking between the particles.

In general, in order for a composite cathode to be effective it is necessary that
1) the solid electrolyte or oxygen-ion conductive phase be continuous
2) the porosity be open and continuous, and
3) the solid electrolyte, porosity, and electrocatalyst phase be contiguous to form a TPB.

The performance of the composite cathode is dependent on a number of intrinsic (fundamental material properties) and microstructural parameters. As indicated above, the losses at the cathode (total polarization) can be divided into two major categories 1) Concentration polarization and 2) Activation polarization. Concentration polarization is primarily related to gas diffusion and transport and can be minimized with thin and highly porous cathode microstructures. Activation polarization is related to the charge transfer process that occurs at the TPB between the gas, solid electrolyte, and electrocatalyst.

Activation polarization is dependent on a number intrinsic properties including the charge transfer resistance of the electrocatalyst and the ionic conductivity of the solid electrolyte material. In addition, the activation polarization of the cathode is largely affected by the microstructure of the composite cathode. Two microstructural parameters of the solid electrolyte phase in the composite cathode that affect activation polarization are 1) particle size and 2) particle to particle neck size. In general, the smaller the particle size of the solid electrolyte (up to a finite limit) the lower the activation polarization. However, if the neck size between the particles is substantially smaller than the particle size, then the effective ionic conductivity of the solid electrolyte phase (in the composite cathode) will be decreased leading to an increase in activation polarization. Therefore, a careful control of both the particle size and neck size is necessary while still maintaining adequate porosity. The “neck” and “neck size” refers to the grain boundary between grains (i.e. particles), where a “neck” is formed between the grains during sintering and is the location of interparticle contact. A small neck size from inadequate sintering indicates poor interparticle contact and results in an increase in polarization. As the sintering temperature increases, the neck size increases and the interparticle contact increases. However, the problem encountered in prior-art systems when the sintering temperature is so increased is a loss of porosity, and/or increased reactions leading to unwanted phases.

An example of a prior art system is disclosed in U.S. Pat. No. 5,543,239 to Virkar et al., which is hereby incorporated by reference. Disclosed an electrode design that is produced by coating slurry of carbon and electrolyte powder upon an electrolyte surface, pressing and heating the object at between about 600° C. and 1000° C. to remove carbon and create a porous surface. The porous surface is then heated to between 1400° C. and 1600° C. to sinter the surface. After sintering an electrocatalyst is introduced into the pores of the porous surface as a solution of salts. The electrode is then heated to 1000° C. to remove the liquid and form an electrocatalyst. This design shows some improvement over conventional designs with non-porous surface because of an enhanced TPB. But, the potential of the electrode is not met because the sintering step required to form the porous surface with sufficient interparticle contact tends to also densify and collapse the porous structure left from the carbon removal. The result is loss of the potential porosity in the structure.

### SUMMARY OF INVENTION

It is apparent that a two-phase composite cathode with substantial porosity, good interparticle contact and high TPB regions is desired to reduce the overpotential losses at the cathode, and increase the overall performance of a solid oxide fuel cell. An aspect of the present invention is a method to fabricate such a composite cathode that produces a highly desirable microstructure while eliminating such processing problems as over-sintering and unwanted chemical reactions.

With reference to FIG. 1, which is a flow sheet illustrating an aspect of the invention, a method for forming a composite cathode upon a ceramic electrolyte surface comprises:
forming a porous structure upon an electrolyte surface of an oxygen ion-conducting ceramic. The porous structure is formed by:
   1. providing a two-phase mixture of an electrolyte, or oxygen-ion conducting primary material, and a fugitive or removable secondary material,
   2. subjecting the mixture to sintering conditions to sinter to the primary material, and
   3. removing the secondary material.
infiltrating the porous structure with a liquid solution containing precursors of an electrocatalytically active material with electrical conductivity,
heating the infiltrated porous structure to a temperature sufficient to convert the precursors to the electrocatalytically active material.

The secondary material supports the primary material during sintering. This allows sintering to occur at temperature high enough to form good necks or interparticle contact in the primary material while at the same time substantially inhibiting the collapse of the porous structure and loss of porosity that would otherwise occur without support of the secondary material. After sintering of the primary material, the secondary material is removed to leave a highly porous structure of the primary material with good interparticle and neck structure.

While the present description is directed toward fuel cells, it is understood that the same methods and cathode structures are also applicable for other analogous electrochemical cell systems, such as sensors, and as catalysts.

The porous structure may be formed by any number of suitable methods that fit within the above requirements to support the primary material during sintering in order to form porous ceramics of high porosity, and high interparticle contact. It has been found, that the sintering of the solid electrolyte phase by itself can lead to either 1) over sintering at high temperatures which results in large particle size, a loss of TPB length, and a reduction in porosity, or 2) partial sintering at lower temperatures which results in incomplete sintering, poor particle to particle necking (small neck size), and thus decreased effective ionic conductivity and large effective ionic resistance.

However, if the solid electrolyte primary phase is sintered with a secondary phase and then this secondary phase is removed, then a more desired microstructure can be obtained. The advantages of this fabrication method which result in a suitably porous structure include: 1) grain growth of the solid electrolyte is inhibited and thus particle sizes can be maintained small, 2) porosity is not decreased with increased sintering, 3) over sintering (and loss of porosity) is essentially not possible, and 4) ability to sinter at high enough temperatures to ensure good particle to particle contact (neck formation). After removal of the secondary phase, the result is a highly porous structure of solid electrolyte with small particle size yet well developed particle-to-particle necks.

The composite cathode of the invention may be deposited upon any suitable electrolyte surface. In a preferred embodiment, the composite cathode is applied upon an electrolyte layer that is in turn deposited upon an anode in an anode-supported cell. However, the invention may also be applied to an electrolyte surface of an electrolyte-supported cell. It is also contemplated within the definition of suitable electrolyte surface, that the composite cathode of the invention also be applied to an existing cathodic surface. In a less preferred embodiment, the composite cathode of the invention may be applied upon a supporting cathode structure of a cathode supported cell, whereupon an electrolyte layer is applied, and finally an anode layer is applied.

After the porous structure is formed, the porous structure is infiltrated with a precursor solution containing dissolved precursors of an electrocatalytically active material. The electrocatalytically active material may be any such material with electrical conductivity known in the art that can be applied by the infiltration method of the invention. After the porous structure is infiltrated, the porous structure is fired at a temperature to convert the precursor materials to an electrocatalytically active material.

The typical composite cathode consists of a porous mixture of an ionic conductor and a predominantly electronic conductor, wherein not only are the two phases and porosity contiguous, but there also exists a large amount of three phase boundary length. Usually, the electronic conductivity of the electronic conductor is much greater than the ionic conductivity of the ionic conductor. As a result, the ionic conductivity of the porous ionic conductor often dictates the overall charge transfer resistance, and the overall cathodic polarization, and thus the cell performance. It is necessary that the ionic conductivity of the ionic conductor be as high as possible or ionic resistivity be as low as possible. This necessitates the use of ionic conductors with as high an ionic conductivity (as low an ionic resistivity) as possible. For a given ionic conductor, in porous bodies, in addition to the grain or particle size, the other factor which governs ionic resistivity is the neck size between two adjacent particles.

Another aspect of the present invention is an electrode comprising a composite cathode. The composite cathode has a porous structure of a solid electrolyte exhibiting oxide ionic conductivity with electrocatalytically active material disposed on the inner walls of the pores as a coating to form high TPB regions. The porous structure is characterized by 1) high porosity, and 2) excellent necking or interparticle contact.

The typical composite cathode microstructure comprises grains, which are polyhedral, with grain boundaries separating adjacent particles of the ion conducting component. Depending upon the neck size, the resistance for ionic transport can vary over a wide range for a given porosity. A schematic of a composite electrode is shown in FIG. 2. The polyhedral grains or particles of an ionic conductor (YSZ) are shown, along with the neck area. The narrower the neck, the greater will be the resistance to ion transport from one grain to another. For the purposes of calculations, the two adjacent grains are approximated by truncated spheres. Half such a sphere (grain or particle) is shown in FIG. 3. The grain radius is given by R. The neck radius is rₒ. The resistance of the grain is given by integrating the net resistance of two regions; (a) the grain region, and (b) the grain boundary region.

The calculations of the resistance for the two regions, the grain and the grain boundary (neck) as a function of relative neck size, as described in terms of the angle θ, are described below. The effective resistivity of such a structure is given below.

$${ρ}_{eff} = \frac{{ρ}_{g}}{2 \sqrt{1 - {α}^{2}}} ln \{ \frac{1 + \sqrt{1 - {α}^{2}}}{1 - \sqrt{1 - {α}^{2}}} \} + \frac{{ρ}_{gb} {δ}_{gb}}{2 R {α}^{2} \sqrt{1 - {α}^{2}}}$$

In the above equation,

$$α = \frac{{r}_{o}}{R} = sin θ$$

ρ_{g} is the grain resistivity, ρ_{gb} is the grain boundary resistivity, and δ_{gb} is the grain boundary thickness. Note that as the neck size becomes very small, that means as α decreases, the effective resistivity of the ionic conductor increases, which is undesirable, since then it increases cathodic polarization resistance. As α becomes very small, the effective resistivity approaches the following equation.

$${ρ}_{eff} \approx \frac{{ρ}_{g}}{2} ln ( \frac{2}{α} ) + \frac{{ρ}_{gb} {δ}_{gb}}{2 R {α}^{2}}$$

It is important to note that as α approaches zero, the effective resistivity approaches infinity. The objective of processing of cathode from a microstructural standpoint is to ensure that α is as large as possible. The effective cathode charge transfer resistance or polarization resistance is given by

$${R}_{ct ( eff )} \approx \sqrt{\frac{2 {ρ}_{eff} {R}_{ct} R}{( 1 - {V}_{v} )}} = \sqrt{\frac{2 {ρ}_{eff} {ρ}_{ct} R}{( 1 - {V}_{v} ) {l}_{TPB}}}$$

according to the theoretical model by Tanner et al. (C. W. Tanner, K-Z. Fung, and A. V. Virkar, Journal of the Electrochemical Society, Volume 144, No. 1, pages 21-30 (1997).)

In a conventionally fabricated cathode, the neck size, α, can often be very small, thus increasing the cathode ionic resistivity and the cathode polarization resistance. In the present invention, the neck size is relatively large by the processing technique developed, whereupon first a complete sintering of a two-phase mixture is achieved, one phase being the ionic conductor and the other phase being a fugitive constituent. This facilitates full neck development. Thereafter, the fugitive constituent is removed, leaving behind a porous network of the ionic conductor with large neck sizes, and thus ensuring low effective ionic resistivity, ρ_{eff}. The final step consists of infiltrating the electronic conductor via, for example, an aqueous salt solution approach. It is believed that through the present method, neck development over the full range of α values can be achieved, usually greater than 0.1, and up to 0.7 and above.

### BRIEF DESCRIPTION OF DRAWINGS

FIG. 1 is a flow sheet showing an aspect of the method of the present invention.

FIG. 2 is a schematic illustrating the neck area and interparticle contact.

FIG. 3 is a diagram showing geometry used for estimating the effective ionic resistivity of porous composite cathodes.

FIG. 4 is a schematic diagram showing a composite cathode of the present invention.

FIG. 5 is a scanning electron micrograph showing the porous YSZ/LSC composite cathode, dense thin film YSZ electrolyte, and porous YSZ/Ni composite anode.

FIG. 6 is a scanning electron micrograph showing the dense thin film YSZ electrolyte having an approximate thickness of 8 μm.

FIG. 7 is a scanning electron micrograph showing the highly porous microstructure of the cathode.

FIG. 8 is a scanning electron micrograph of the LSC/YSZ composite cathode. The points A and B refer to locations where electron dispersive spectroscopy (EDS) was performed with the compositional results shown in FIG. 9A and FIG. 9B.

FIG. 9A and FIG. 9B are compositional spectra from EDS performed at points A (FIG. 9A) and B (FIG. 9B) in the composite cathode as shown in FIG. 6.

FIG. 10 is an X-ray diffraction (XRD) pattern of a cell with an LSC/YSZ composite cathode taken after infiltration and heating at 800° C. for 2 hours. The nickel detected is from the porous Ni/YSZ anode. The pattern shows the formation of the perovskite LSC after heating at 800° C.

FIG. 11 is a graph showing power density and voltage curves as a function of current density for a cell with a LSC/YSZ composite cathode fabricated by infiltration.

FIG. 12 is a graph showing power density and voltage curves as a function of current density for a cell with a LSM/YSZ composite cathode fabricated by infiltration.

FIG. 13 is a graph showing performance of cells with composite cathodes consisting of LSC+YSZ, with the number of LSC infiltrations varied between 1 and 4 times. Tested at 800° C. with hydrogen and air.

FIG. 14 is an SEM micrograph showing composite cathode interlayer of YSZ with infiltrated LSC.

FIG. 15 is an SEM micrograph showing composite cathode interlayer of YSZ with infiltrated LSC.

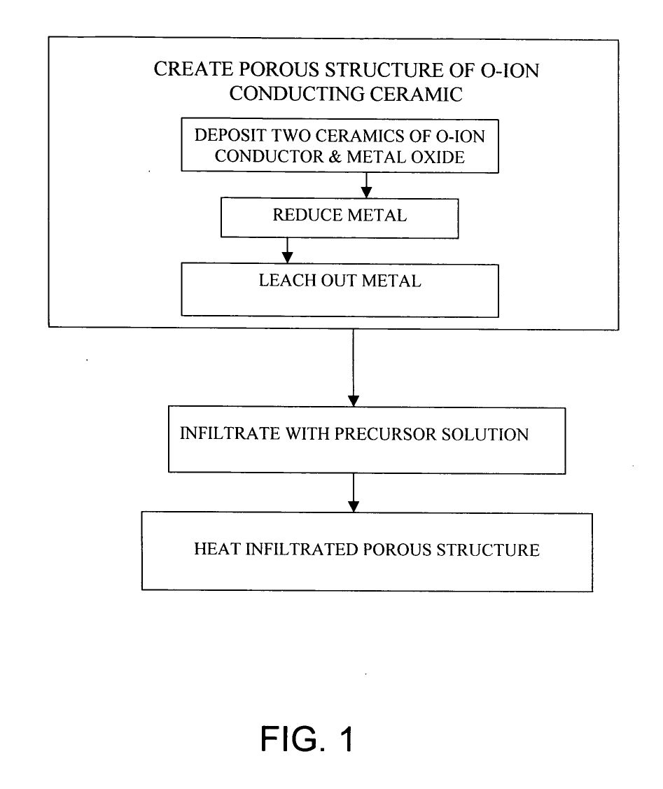

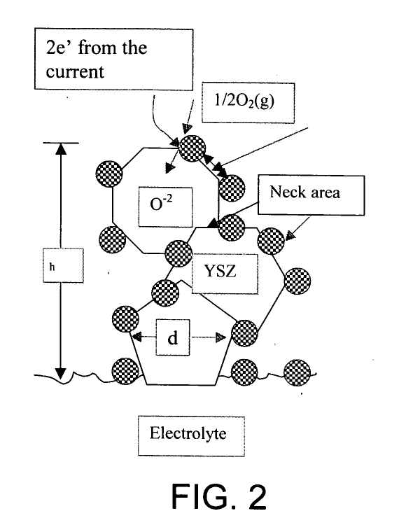

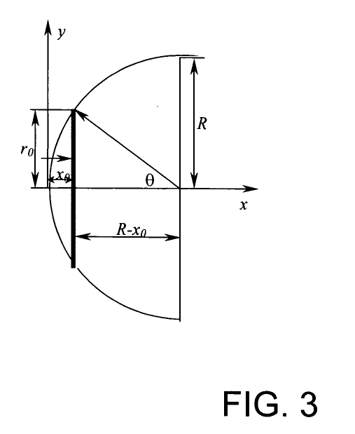

### DETAILED DESCRIPTION

Forming the Porous Structure

In the preferred method of the present invention, a two-phase composite, which is a precursor to the porous structure, is formed by applying on the electrolyte surface a composite mixture of an electrolyte material (an oxygen conducting ceramic) and a secondary material, and sintering these together to form a composite of a primary phase of the oxygen conducting ceramic and a secondary phase of the secondary material. The porous structure is then produced by removing the secondary phase.

The two-phase composite can be formed by any suitable method by depositing or applying a two-phase ceramic/material upon the surface where the composite cathode is to be formed, usually an electrolyte surface.

The method for depositing the two-phase precursor may be any suitable method, including, but not limited to, CVD, PVD, painting, screen-printing, sputtering, spraying, and drop coating. After application of the two-phases, the coating is heat-treated to crystallize and/or sinter the coating.

The oxygen ion conducting ceramic may be any suitable ceramic used as an electrolyte material. Examples include, but are not limited to known oxygen-ion conductors, such as zirconia and its various forms, e.g., yttria stabilized zirconia, rare-earth-oxide-stabilized zirconia, and scandia-stabilized zirconia, and ceria ceramics, e.g., rare-earth doped ceria and alkaline-earth doped ceria, stabilized hafnia, rare-earth oxide stabilized bismuth oxide, and thoria. Specific examples include samaria-stabilized ceria (SDC) or La₁₋ₓSrₓGa_{1-y}Mg_{y}O_{3-δ} (LSGM).

The secondary material is a material that is compatible with the electrolyte material, which means it is sufficiently unreactive and stable with respect to the electrolyte material. In addition, the secondary material should be able to restrict the grain growth of the electrolyte material and thus mitigate the loss of porosity with sintering, yet not interfere with the growth of necks for interparticle contact.

The secondary material must also be removable. The process of removing the secondary material may involve one or a combination of these processes; chemical reaction of the secondary phase (reduction or oxidation), treatment to change the secondary phase to a gas or liquid, solubilization of the secondary phase, and heating to fluidize (melt or vaporize) the secondary phase. Set forth below are exemplary methods for forming a porous structure using various secondary materials and processes of removal.

Examples of Forming the Porous Structure

(1) Metal Oxide Reduction/Removal Method

In this method the solid electrolyte material is sintered with a metal oxide, e.g., NiO, that is subsequently reduced to a metal and removed via an acid leaching process. In general, the method comprises;
depositing a two-phase ceramic comprising an oxygen ion-conducting ceramic and an oxide of a metal that is reducible to the elemental metal,
reducing the metal oxide to the metal to form a cermet of the oxygen-ion conducting ceramic and the metal,
leaching out the metal from the cermet to form a porous structure of the oxygen ion conducting.

The metal oxide component in the coating is reduced to the metal. This can be accomplished, for example, by exposing the coating to hydrogen (or other suitable reducing gas) at a sufficiently high temperature. After the metal is reduced, it is removed, preferably by leaching, or like process, such as by the use of dilute acids.

The metal oxide is an oxide of a metal that can be reduced and leached. Suitable metal oxides include, but are not limited to, nickel, copper, iron, zinc oxides, or mixtures thereof. The metal oxide is also chosen to be chemically compatible, i.e., essentially nonreactive, with the oxygen-ion-conducting ceramic, and such that it doesn't form undesired phases during processing.

An example of this method using a NiO—YSZ ceramic coating is described below. But present invention is not limited to these materials. Any solid electrolyte material may be coupled with a suitable chemically compatible metal oxide. For example, other solid electrolyte materials such as samaria-doped ceria (SDC) could be coupled with NiO, or transition metal oxides other than NiO, such as CuO, FeO, CoO, and ZnO. In addition, La₁₋ₓSrₓGa_{1-y}Mg_{y}O_{3-δ} (LSGM) could be coupled with ZnO. (NiO, CuO, FeO, and CoO are reactive with LSGM and accordingly are not suitable for coupling with LSGM.) The reduction and removal of the metal Ni, Cu, Zn, Co, or Fe would leave porous bodies of SDC or LSGM that could be infiltrated with the electrocatalyst of choice.

(2) Metal Oxide Reduction/Removal Method by Vaporization

This method begins the same as (1) but the metal is removed by melting or vaporizing the metal. A metal oxide is added to the solid electrolyte material. The mixture is sintered in air. After sintering in an oxidizing atmosphere (air), the atmosphere is changed to a reducing atmosphere (hydrogen) and the metal oxide phase is reduced to it metal state. The temperature is raised to above the melting and/or boiling point of the metal and the metal phase is removed by vaporization. An example of suitable metal oxide is ZnO.

(3) Metal Oxide Removal Method

An oxide is added to the solid electrolyte material, sintered, and then removed by a leaching process. Similar to (1), but no reduction of the oxide is necessary. Criteria for the selection of the second oxide phase: a) does not react with solid electrolyte phase, b) melts at a temperature higher than the processing temperature, and c) is soluble in a solvent; water or dilute acid solution. Examples include: ZnO, LiBO₂, K₄P₂O₄.3H₂O, K₂WO₄, AlNaO₂, and Al₂CaO₄.

(4) Secondary Phase Removal Method by Gas Chemical Reaction

A secondary phase (oxide, metal, salt) is added to the solid electrolyte material and removed by a solid to gas phase transformation (or liquid to gas phase transformation). For example: NiO is added to the solid electrolyte material and sintered in air. After sintering in an oxidizing atmosphere (air), the atmosphere is changed to a reducing atmosphere (hydrogen), and thus reducing the metal oxide to its metal state. Then the atmosphere is changed to a gas species that reacts with the metal. In this case, a suitable gas is CO, which reacts with solid Ni metal to form the gas phase Ni(CO)₄. Alternatively, the secondary phase may be transformed into a liquid before it is reacted with the gas species, such as in the case where a solid metal oxide is reduced to a metal at a temperature above its melting point.

(5) Organic Pore Former and Oxidation Method

Add an organic material such as carbon, starch, cellulose, or various polymers to the solid electrolyte material. The mixture is sintered in air wherein the organic pore former is decomposed, oxidized, and removed as a gas species. The conditions are chosen such that the electrolyte sufficiently sinters before the organic material is removed, so that the carbon inhibits grain growth and porosity loss before it is removed. Under these conditions, the porous structure is supported by the organic material while sintering occurs, such that when the organic material is eventually removed, the structure is already sufficiently sintered to resist densification and that otherwise would occur of the porous structure was not supported during sintering.

(6) Organic Pore Former and Cosinter/Oxidation Method

An organic material is added to the solid electrolyte materials as described above in (5). First, the mixture is sintered in a reducing atmosphere (e.g., hydrogen) such that the solid electrolyte and carbonaceous materials sinter together forming a two phase composite. The presence of the carbonaceous phase prevents excessive grain growth of the solid electrolyte, over sintering, and reduction in porosity, yet allows for adequate sintering such that complete neck formation occurs between the solid electrolyte particles. After sintering in a reducing atmosphere (e.g. hydrogen), the atmosphere is switched to an oxidizing atmosphere (e.g., air) and the organic pore former is oxidized and removed as a gas species. Suitable carbonaceous materials included, but are not limited to those above and carbon powder.

(7) Soluble Salt Method

A salt is added to the solid electrolyte material. The mixture is sintered in air, cooled to room temperature, and the salt is removed with water or a dilute acid solution. The criteria for the salt are that it: a) does not react with the solid electrolyte, b) melts at a high temperature (relative to the processing temperature), c) has low vapor pressure at high temperatures, and d) is soluble in a solvent; water, dilute acid solution, alcohol. Examples of suitable salts include but are not limited to LiF, K₂S, and NaCl

(8) Vaporizable/Meltable Salt Method

A salt is added to the solid electrolyte material and removed by a vaporization process. A salt is added to the solid electrolyte material and sintered in air at a temperature below the melting point of the salt. After sintering, the temperature is raised to above the melting or boiling point of the salt and the salt is removed by vaporization. A desirable salt is one that: a) does not react with the solid electrolyte, b) melts at a high temperature (relative to the processing temperature), c) yet has high vapor pressure at temperatures above its melting point.

Ideally, the melting point of the salt is far below that of the oxygen conducting ceramic. However, the salt must melt at a temperature above which sintering of the oxygen conducting ceramic typically occurs. For example, the YSZ phase in the composite cathode can be sintered in the temperature range between 1000-1200° C. Therefore, the melting temperature of the salt must be above the actual sintering temperature that is used, 1100° C. for example. An example of a possible material is indium fluoride (InF₃), which melts at 1170° C. and has a boiling point above 1200° C. The two phase material (YSZ and InF₃) could be sintered at 1100° C. for a period of time, and then the temperature increased to above 1200° C. for a short period of time to remove the InF₃.

Infiltration of the Porous Structure

After the porous structure is formed, the porous structure is infiltrated with a precursor liquid containing in proportion the components of an electrocatalytically active material, and that form the electrocatalytically active material upon heating. The preferred liquid is a solution containing dissolved precursors of an electrocatalytically active material. The electrocatalytically active material can include any electrocatalyst, such as, for example, any one or a mixture of metal oxides, such as La₁₋ₓSrₓMnO₃ (LSM), La₁₋ₓSrₓCoO₃ (LSC), La₁₋ₓSrₓFeO₃ (LSF), SrFeCo_{0.5}Oₓ, SrCo_{0.8}Fe_{0.2}O_{3-δ}, La_{0.8}Sr_{0.2}Co_{0.8}Ni_{0.2}O_{3-δ}, and La_{0.7}Sr_{0.3}Fe_{0.8}Ni_{0.2}O_{3-δ}, La₂NiO₄, or noble metals (such as silver, platinum, palladium, rhodium). Suitable electrocatalysts include those disclosed in U.S. Pat. No. 5,543,239, which is hereby incorporated by reference. The solution is formulated to contain metal ions in the same proportion as in the electrocatalytically active material. The solution may comprise any solute and soluble salt material that allows formation of the solution. Examples include aqueous and alcohol solution of nitrates and, organic-metallic soluble materials, such as transition-metal based oxalates, acetates, and citrates. The solution should have the suitable wetability, and solubility properties to permit the solution to infiltrate the porous structure and distribute the precursors of the electrocatalytically active material throughout the porous structure.

Another suitable liquid is a mixture of liquid salts. Metal salts with low melting temperatures could be mixed in appropriate ratios, melted into a liquid, and then infiltrated. Precursor materials including nitrates, hydroxides, acetates, oxalates, stearates, and carbonyls could be used. For example, in order to form LSM, mixtures of La nitrate (m.p. 40° C.), Sr acetate (m.p. 150° C.), and Mn acetate (m.p. 80° C.) could be mixed, melted, and then infiltrated into the porous body.

Heating to Form the Electrocatallytically Active Material

After the porous structure is infiltrated, the porous structure is fired at a temperature to convert the precursor materials to an electrocatalytically active material. To form LSM, from an infiltrated precursor solution a suitable temperature is between 500° C. and 800° C. This temperature range would be suitable for most other catalytic systems. It should be noted that the temperature is substantially lower than that required for prior-art composite cathodes to sinter together the composite cathode. For example, for LSM and YSZ, the temperature was greater than 1000° C. The result in the present invention is a dramatic reduction or elimination of problems of the loss of porosity, the reduction of TPB length, and formation of undesired and insulating phases.

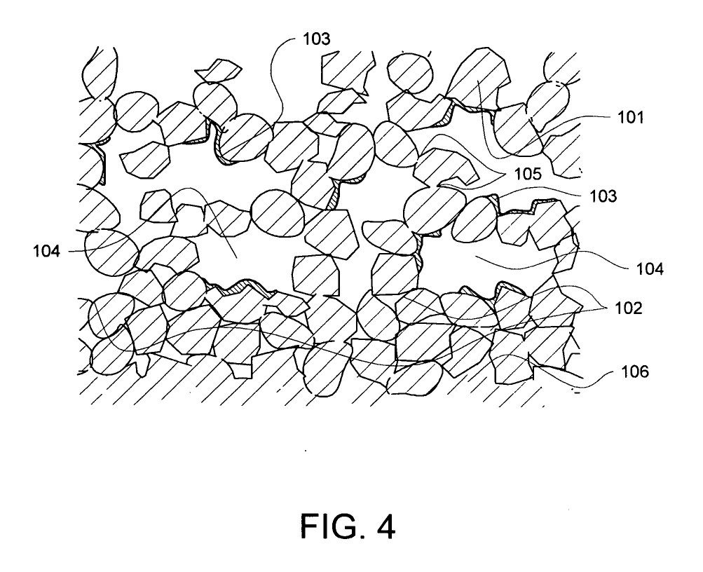

With reference to FIG. 4, which is a schematic of a composite cathode of the invention, the composite cathode comprises a porous structure of the oxygen-ion conducting ceramic 101 disposed upon a surface 102 of an electrolyte 106. Upon the surface of the oxygen-ion ceramic is an electrocatalytically active material 103. The three-phase boundaries are increased by the porosity of the composite cathode due to the porous structure of the ion-conducing ceramic, the manner in which the electrocatalytically active material is disposed in the pores 104 and its relation with respect to the both the pore (where the reactive oxygenating gas flows) and the oxygen-ion conductor, and the lack of undesirable phases that interfere with the function of the composite cathode. Interparticle contact is improved since the process of the present invention allows for formation of good necks 105.

### EXAMPLE

This example illustrates an embodiment of the present invention. In this example, a two-phase ceramic consisting of NiO and YSZ is deposited on the surface of the electrolyte where the cathode is intended, by applying a NiO and YSZ mixture and sintering. While the sintering temperature, about 1400° C., is high, the presence of the two phases inhibits grain growth and thus prevents over-coarsening of the microstructure.

The NiO—YSZ ceramic is exposed to a hydrogen environment at high temperature in order to reduce the NiO and thus form a Ni—YSZ cermet. The Ni is subsequently leached out with a dilute acid leaving behind a highly porous YSZ structure. The porous structure is then infiltrated with a solution containing La, Sr, and Mn nitrates and fired at low temperatures (500-800° C.) to form LSM. The result is a porous composite cathode consisting of LSM and YSZ. Alternatively, the porous YSZ structure can be fabricated by depositing a layer of YSZ containing a pore former, such as carbon, and then heated at temperatures between 1000 and 1200° C. The resulting porous structure can then be infiltrated with a precursor solution.

Experimental Procedure

Porous Ni/YSZ anodes and thin film YSZ electrolytes were prepared using standard techniques. The first step in fabricating the composite cathode is the deposition of a two-phase NiO—YSZ ceramic thin coating. The NiO—YSZ coating can be deposited by various methods including, but not limited to, CVD, PVD, sputtering, or painting, screen-printing, spraying, and drop coating, followed by a heat treatment. In this example, deposition was done by sputtering, spraying, and drop coating followed by sintering. Sputtering of a 1 μm thick NiO—YSZ coating was done directly on the sintered YSZ electrolyte using a single NiO—YSZ target. Sputtering of NiO—YSZ can also be achieved by co-depositing from two different targets, one YSZ and one NiO. The sputtered coating was heat treated at 800° C. to fully crystallize the coating. Deposition by spraying was done with a milled mixture of NiO and YSZ powder suspended in alcohol and sprayed directly onto the sintered YSZ electrolyte. In a third method, a NiO—YSZ coating was applied by drop coating a solution, consisting of NiO and YSZ powder suspended in alcohol, on a bisqued (not fired) YSZ electrolyte. The NiO—YSZ coating thickness ranged from thousands of angstroms (sputtering) to tens of microns (drop coating). The relative composition of the deposited layers ranged between 30 wt % NiO-70 wt % YSZ to 70 wt % NiO-30 wt % YSZ. The coatings deposited by spraying and drop coating were sintered at 1400° C. for 2 hours. Although the sintering temperature of 1400° C. is high, the presence of the two phases inhibits grain growth and thus prevents over-coarsening of the microstructure.

In order to reduce the NiO to form a Ni—YSZ cermet, the NiO—YSZ coating was exposed to a hydrogen environment. The spray coated and sputter coated samples were exposed to a hydrogen environment at 700° C. for 10 minutes. The NiO—YSZ coatings were less than 1 μm thick, thus the time required to fully reduce the NiO in the thin coating was short enough that the body of the anode was unaffected. On the other hand, the NiO—YSZ layers deposited by drop coating were on the order of 30 to 50 μthick. Thus, the coatings were reduced in a fixture such that the coating was exposed to the reducing environment for 30 minutes at 800° C. while the anode was exposed to air to prevent reduction.

The Ni metal was leached out of the Ni—YSZ cermet by soaking the coating in dilute nitric acid. The time required to fully leach out the Ni ranged between 10 minutes and 1 hour depending on the coating thickness and acid molarity. The removal of the Ni from the cermet resulted in a highly porous framework of YSZ.

In order to form the composite cathode, the electrocatalyst must be added to the highly porous YSZ. This was accomplished by infiltrating the porous coating with nitrate solutions. For example, with the intention of forming La_{0.8}Sr_{0.2}MnO_{3-δ}, requisite amounts of La(NO₃)₃, Sr(NO₃)₂, and Mn(NO₃)₂.xH₂O were dissolved in ethyl alcohol. The resulting solution was repeatedly drop coated on the porous YSZ coating with periods of drying time between applications. After infiltration, the cells were heated at temperatures between 500 and 800° C. for 2 hours in order to form La_{0.8}Sr_{0.2}MnO_{3-δ} within the porous YSZ framework. Similarly, La_{0.6}Sr_{0.4}Co_{3-δ} was successfully synthesized within the porous YSZ framework by infiltrating with a solution consisting of La(NO₃)₃, Sr(NO₃)₂, (CH₃CO₂)₂Co.4H₂O and ethyl alcohol.

Results

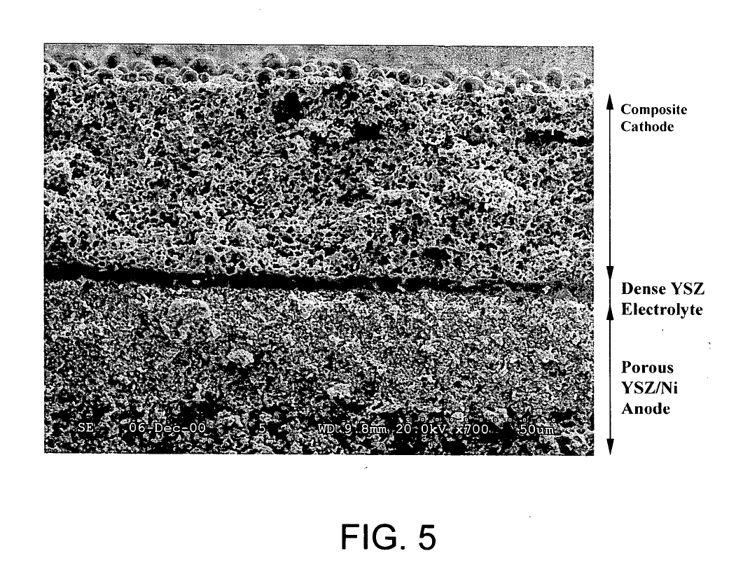

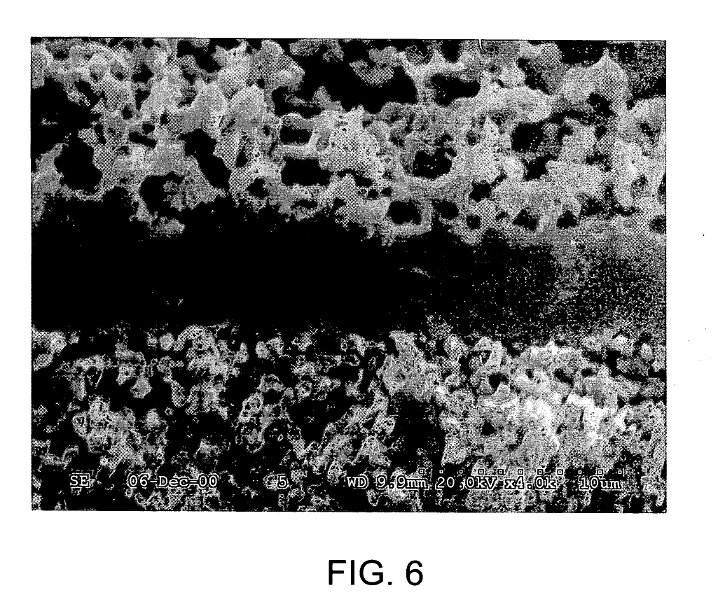

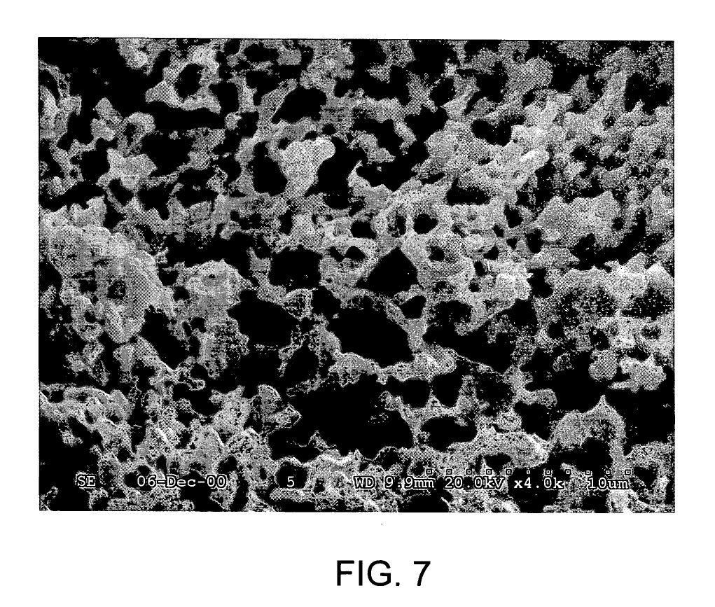

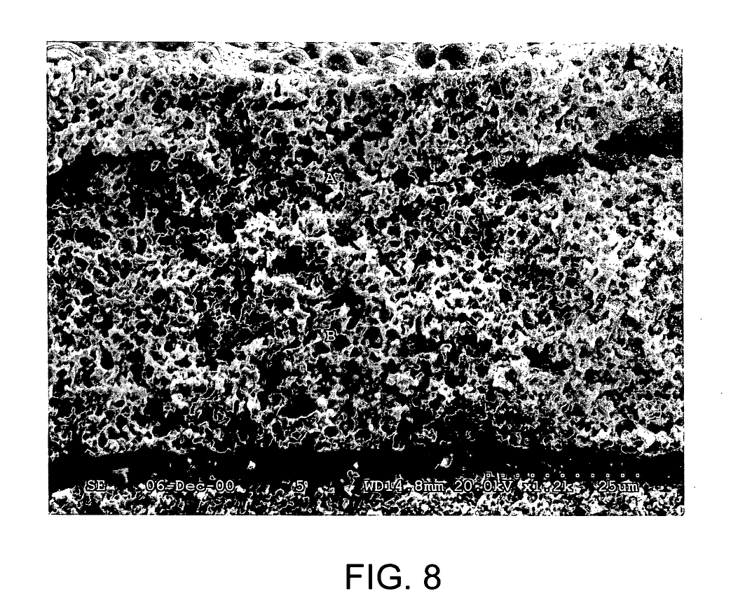

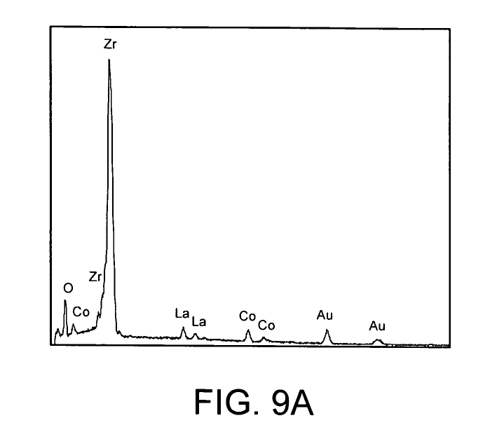

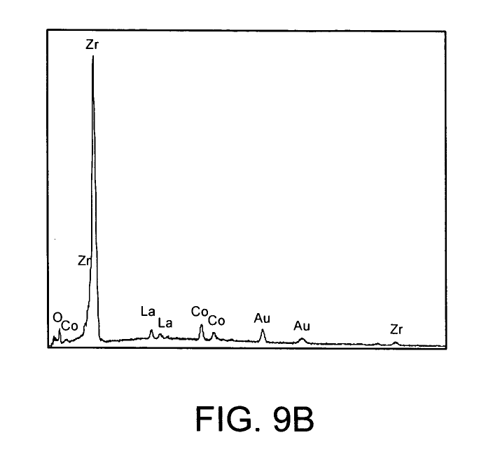

A composite cathode was formed as described above. The results shown are for cathodes in which the original NiO—YSZ coating was deposited on the electrolyte by drop coating. FIG. 5 shows the components of the cell including the porous Ni/YSZ anode, the dense YSZ electrolyte, and the porous composite cathode. In this case, the porous YSZ framework was infiltrated with an alcohol solution containing La, Sr, and Co nitrates and heated at 800° C. for 2 hours to form La_{0.6}Sr_{0.4}CoO_{3-δ} (LSC). As shown, the composite cathode fabricated by drop coating is thicker than desired with an approximate thickness of 65 μm. In FIG. 6 is shown the interface between the dense YSZ electrolyte (8 μm thick) and the cathode. FIG. 7 shows that even after infiltration, the composite cathode is highly porous due to the open nature of the YSZ framework. Electron dispersive spectroscopy (EDS) was performed at various points within the composite cathode to insure that complete infiltration was achieved and was not limited to the surface regions. FIG. 8 shows an LSC/YSZ composite cathode and the location where EDS was performed. The EDS results for these points are presented in FIG. 9A and FIG. 9B. As evident in the figures, the presence of La and Co at both points A (FIG. 9A) and B (FIG. 9B) indicates that infiltration is indeed occurring throughout the porous framework and not limited to the surface. Note that nickel is not present indicating that it was completely removed during the leaching process.

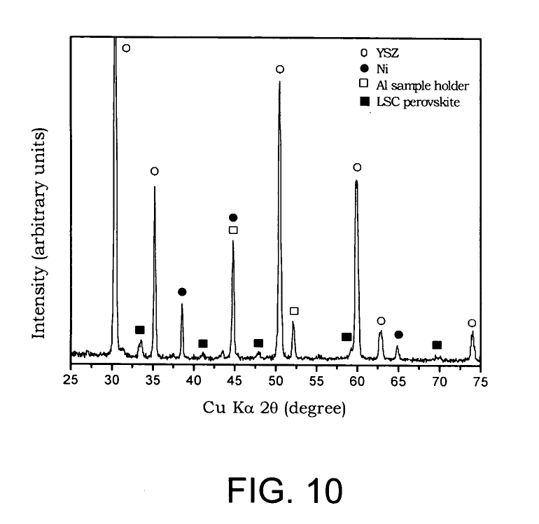

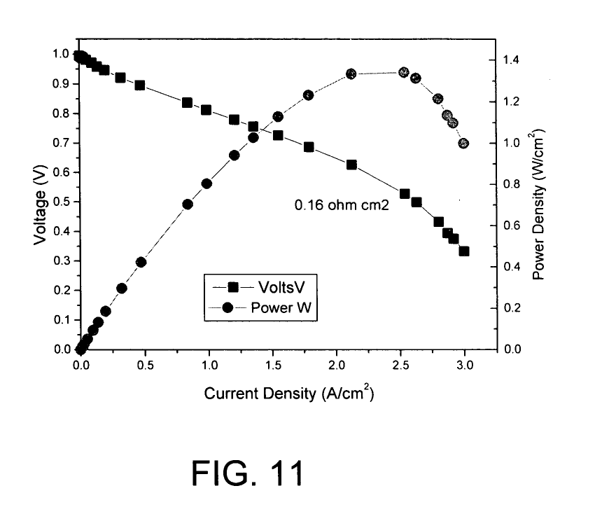

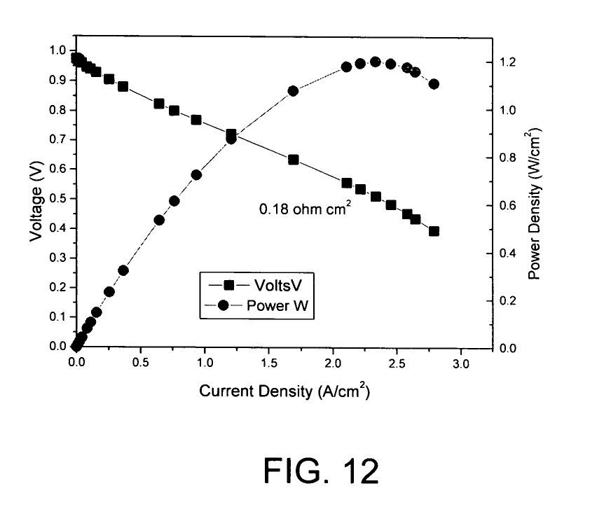

FIG. 10 shows an X-ray diffraction pattern of the LSC/YSZ composite cathode. The presence of the perovskite phase confirms that the infiltrated solution is forming LSC even at the low synthesis temperature of 800° C. The strong YSZ pattern is from the YSZ in the cathode, anode, and dense electrolyte, while the detection of Ni is from the Ni in the anode. Anode supported cells with thin film YSZ electrolytes and composite cathodes were tested at 800° C. with air as the oxidant and humidified hydrogen as the fuel. The results for a cell containing an LSC/YSZ composite cathode are shown in FIG. 11. A maximum power density of 1.3 W/cm² was achieved while the total area specific resistance (ASR) of the cell was approximately 0.16 Ωcm². Similarly, a single cell was tested with an LSM/YSZ composite cathode with the results shown in FIG. 12. The maximum power density was 1.2 W/cm² with an ASR of 0.18 Ωcm².

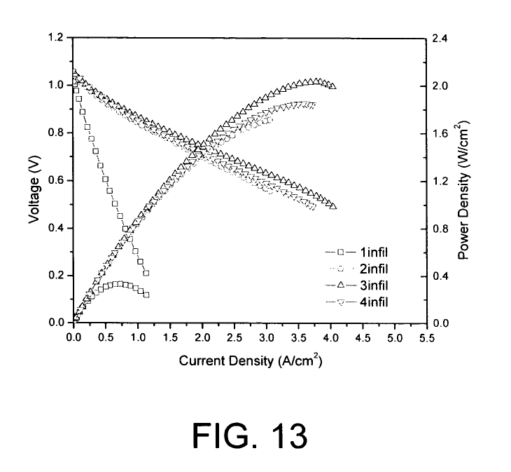

FIG. 13 is a graph showing performance of cells with composite cathodes consisting of LSC+YSZ, with the number of LSC infiltrations varied between 1 and 4 times. Testing was done at 800° C. with hydrogen and air. Maximum power density shown is greater than 2.0 w/cm², which is significantly better than the results for cells currently commercially available.

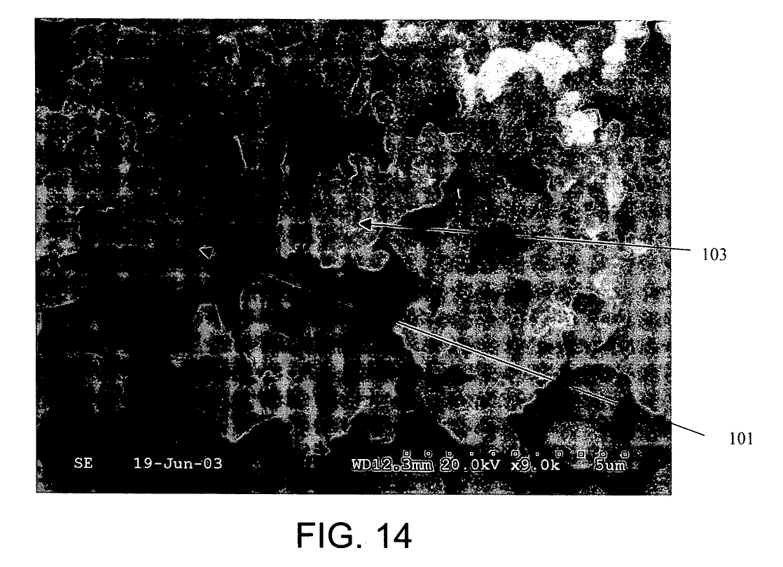

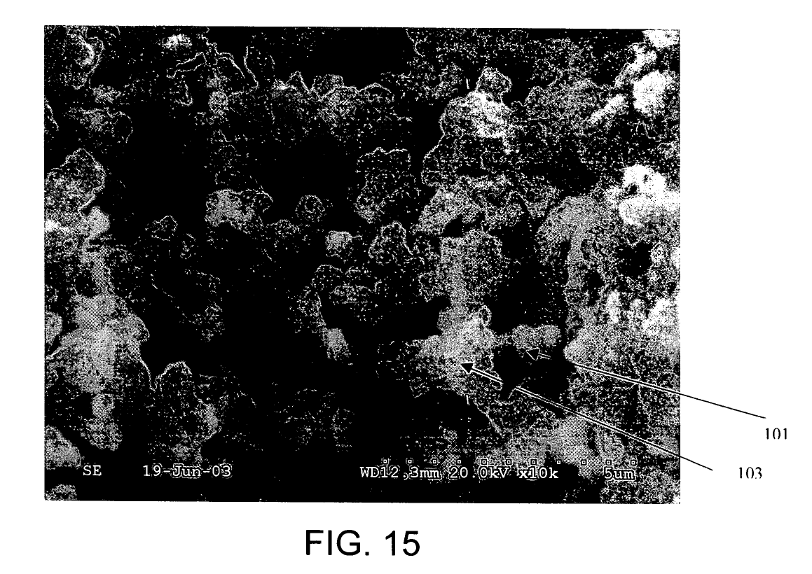

FIG. 14 and FIG. 15 are SEM micrographs showing composite cathode interlayer of YSZ with infiltrated LSC. Shown in FIG. 14 and FIG. 15 is the YSZ that forms the porous ceramic structure 101, and LSC 103 deposited within the pores and on the YSZ surface. Note that there is more LSC present in the cathode interlayer of FIG. 14 as compared to FIG. 15.

Although this description refers to anode-supported cells, this composite cathode fabrication technique is not limited to such cells and could be used on cathode or electrolyte supported solid oxide fuel cells.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention. Although some embodiments are shown to include certain features, the inventors specifically contemplate that any feature disclosed herein may be used together or in combination with any other feature on any embodiment of the invention.

1. A method for forming a composite cathode upon a ceramic electrolyte surface comprising:
depositing a two-phase mixture of an oxygen-ion conducting ceramic primary material, and a fugitive or removable secondary material on the ceramic electrolyte surface,
subjecting the mixture to sintering conditions to sinter to the primary material, and the secondary material having properties such that during sintering the secondary material resists densification and grain growth of the primary material under sintering conditions that permit the growth of interparticle contact,
removing the secondary material to form a porous structure of the primary material to form a porous ceramic structure of the primary material,
infiltrating the porous structure with a liquid containing precursors of an electrocatalytically active material, the precursors containing metal ions in the same proportion as that in the electrocatalytically active material;
heating the infiltrated porous structure to a temperature sufficient to convert the precursors to the electrocatalytically active material.

2. A method for forming a composite cathode upon a ceramic electrolyte surface as in claim 1 wherein the porous ceramic structure comprises one or more of zirconia, ceria, stabilized hafnia, bismuth oxide, and thoria.

3. A method for forming a composite cathode upon a ceramic electrolyte surface as in claim 2 wherein the porous ceramic structure comprises one of more of yttria stabilized zirconia, rare-earth-oxide-stabilized zirconia, scandia-stabilized zirconia, rare-earth doped ceria, alkaline-earth doped ceria, stabilized hafnia, rare-earth oxide stabilized bismuth oxide.

4. A method for forming a composite cathode upon a ceramic electrolyte surface as in claim 2 wherein the porous ceramic structure comprises one or more of samaria-stabilized ceria (SDC) or La₁₋ₓSrₓGa_{1-y}Mg_{y}O_{3-δ}, (LSGM).

5. A method for forming a composite cathode upon a ceramic electrolyte surface as in claim 1 wherein the electrocatalytically active material is any one or a mixture of LSM, LSC, LSF, SrFeCo_{0.5}Oₓ, SrCo_{0.8}Fe_{0.2}O_{3-δ}, La_{0.8}Sr_{0.2}Co₀₈Ni_{0.2}O_{3-δ}, and La_{0.7}Sr_{0.3}Fe_{0.8}Ni_{0.2}O_{3-δ, La}₂NiO₄, or noble metals.

6. A method for forming a composite cathode upon a ceramic electrolyte surface as in claim 1 wherein the secondary material is a metal oxide that is reducible to a metal, and wherein the removing the secondary material comprises reducing the metal oxide to the metal to form a cermet of the oxygen-ion conducting ceramic and the metal, and leaching the metal from the cermet.

7. A method for forming a composite cathode upon a ceramic electrolyte surface as in claim 2 wherein the metal oxide is one or more of NiO, CuO, FeO, CoO, and ZnO.

8. A method for forming a composite cathode upon a ceramic electrolyte surface as in claim 1 wherein the secondary material is a metal oxide that is reducible to a metal, and wherein the removing the secondary material comprises reducing the metal oxide to the metal to form a cermet of the oxygen-ion conducting ceramic and the metal, and heating the cermet to melt or vaporize the metal to form the porous structure of the oxygen ion conducting ceramic.

9. A method for forming a composite cathode upon a ceramic electrolyte surface as in claim 8 wherein the metal oxide is ZnO.

10. A method for forming a composite cathode upon a ceramic electrolyte surface as in claim 1 wherein the secondary material is a metal oxide that is non-reactive with the oxygen conducting ceramic, melts at a temperature higher than processing temperatures, and is soluble in a liquid solvent;
and wherein the removing comprises leaching out the metal oxide with the solvent to form the porous structure of the oxygen ion conducting ceramic.

11. A method for forming a composite cathode upon a ceramic electrolyte surface as in claim 10 wherein the solvent is water or dilute acid solution, and wherein the metal oxide is one of more of ZnO, LiBO₂, K₄P₂O₄.3H₂O, K₂WO₄, AlNaO₂, or Al₂CaO₄.

12. A method for forming a composite cathode upon a ceramic electrolyte surface as in claim 1 wherein the secondary material is a material reactive with a reactant to form a liquid or gas, and the removing comprises reacting the secondary material with the reactant.

13. A method for forming a composite cathode upon a ceramic electrolyte surface as in claim 12 wherein the secondary material is Ni or a material that can form Ni, the reactant is CO, and the reacting forms gas phase Ni(CO)₄.

14. A method for forming a composite cathode upon a ceramic electrolyte surface as in claim 13 wherein the secondary material is NiO and the secondary material is reduced to Ni by exposure to a reducing atmosphere before reacting with the reactant CO.

15. A method for forming a composite cathode upon a ceramic electrolyte surface as in claim 1 wherein the secondary material is a pore former that can be decomposed when heated in an oxidizing atmosphere, and the removing comprises heating in an oxidizing atmosphere to decompose the pore former.

16. A method for forming a composite cathode upon a ceramic electrolyte surface as in claim 15 wherein the secondary material is one or more of carbon, starch, cellulose, or a polymer

17. A method for forming a composite cathode upon a ceramic electrolyte surface as in claim 15 wherein the sintering is in a reducing atmosphere, and thereafter the atmosphere is switched to an oxidizing atmosphere for the heating in an oxidizing atmosphere.

18. A method for forming a composite cathode upon a ceramic electrolyte surface as in claim 1 wherein the secondary material is a salt that is nonreactive with the oxygen conducting ceramic, melts at a temperature higher than processing temperatures, has low vapor pressure at high temperatures sufficient to inhibit its loss during sintering, and is soluble in a solvent, and the removing comprises treating the composite of the oxygen conducting ceramic and a secondary phase of the secondary material with the solvent to dissolve the salt in the solvent.

19. A method for forming a composite cathode upon a ceramic electrolyte surface as in claim 18 wherein the solvent is one or more of water, dilute acid solution, and alcohol, and the salt is soluble in the solvent.

20. A method for forming a composite cathode upon a ceramic electrolyte surface as in claim 19 wherein the salt is one or a more of KCl, LiF, K₂S, and NaCl.

21. A method for forming a composite cathode upon a ceramic electrolyte surface as in claim 1 wherein the secondary material is a salt that is nonreactive with the oxygen conducting ceramic, melts at a lower temperature relative to the processing temperature, has a vapor pressure at high temperatures sufficient to be removed, and the removing comprises heat treating the composite of the oxygen conducting ceramic and a secondary phase of the secondary material to a temperature above the melting or boiling point of the salt to remove the salt by vaporization.

22. A method for forming a composite cathode upon a ceramic electrolyte surface as in claim 1 wherein the liquid for the infiltrating is a solution containing dissolved precursors of the electrocatalytically active material.

23. A method for forming a composite cathode upon a ceramic electrolyte surface as in claim 22 wherein the solution contains precursors for the electrocatalytically active material, the electrocatalytically active materials being one or more of LSM, LSC, LSF, SrFeCo_{0.5}Oₓ, SrCo_{0.8}Fe_{0.2}O_{3-δ}, La_{0.8}Sr_{0.2}Co_{0.8}Ni_{0.2}O_{3-δ}, and La_{0.7}Sr_{0.3}Fe_{0.8}Ni_{0.2}O_{3-δ}, La₂NiO₄, silver, platinum, palladium, or rhodium.

24. A method for forming a composite cathode upon a ceramic electrolyte surface as in claim 1 wherein the liquid for the infiltrating is mixture of liquid salts.

25. A method for forming a composite cathode upon a ceramic electrolyte surface as in claim 1 wherein the heating is at a temperature between 500° C. and 800° C.
